(19) United States
(12) Patent Application Publication
(10) Pub. No.: US 2023/0311290 A1
(43) Pub. Date: Oct. 5, 2023

(54) OIL UNIT AND POWER TOOL

(71) Applicant: MAKITA CORPORATION, Anjo-shi (JP)

(72) Inventor: Koji TAKAHAGI, Anjo-shi (JP)

(73) Assignee: MAKITA CORPORATION, Anjo-shi (JP)

(21) Appl. No.: 18/178,111

(22) Filed: Mar. 3, 2023

(30) Foreign Application Priority Data
Apr. 5, 2022 (JP) 2022-063072

(51) Int. Cl. B25D 17/26; B25D 11/06

(52) U.S. Cl. CPC B25D 17/26; B25D 11/066

(57) ABSTRACT

To prevent, for example, a tube in a case from blocking an oil port, an oil unit includes a case that contains oil, a blade inside the case, an output shaft holding the blade and protruding from the case, at least one oil port formed on the case, a hollow tube adjacent to an inner surface in which the at least one oil port is open in the case, and a flow channel definer positioning the tube adjacent to an opening of the at least one oil port in the inner surface at a predetermined position and defining a flow channel of oil to flow into the case through the opening.

### CROSS-REFERENCE TO RELATED APPLICATIONS

This application claims the benefit of priority to Japanese Patent Application No. 2022-063072, filed on Apr. 5, 2022, the entire contents of which are hereby incorporated by reference.

### BACKGROUND

### 1. Technical Field

The present disclosure relates to an oil unit for outputting impact torque in a power tool such as a soft impact driver, and to a power tool with the oil unit.

### 2. Description of the Background

A power tool such as a soft impact driver includes an oil unit that outputs, through a spindle, intermittent impact torque (impact) caused by rotation of a motor. A known oil unit is described in, for example, Japanese Unexamined Patent Application Publication No.

2021-122906. The known oil unit includes a case containing oil, through which the rotation of a motor is transmitted, and a spindle having a rear portion placed in the case in a rotatable manner. The spindle receives, in the rear portion, a cam that rotates integrally with the case at the center of the case. The spindle accommodates a pair of balls and a pair of blades both in a radially movable manner in the rear portion outside the cam.

In such a known oil unit, the cam integral with the case rotates as the case rotates, pushing the blades radially outward with the balls in the rear portion of the spindle. When the cam seals the rear portion of the spindle in the case at a predetermined rotational position, the blades being pushed out are retained at the position under oil pressure. The blades hitting projections in the case produce impact torque (impact). When the cam then rotates together with the case, the oil in the rear portion of the spindle flows out and reduces the oil pressure. This allows the blades to retract into the rear portion of the spindle and move relatively over the projections. The repeated motions of the blades being pushed out, hitting the projections, and retracting produce impacts intermittently.

Another known oil unit without including balls may use rotation of a case relative to a spindle to swing blades in the case and change oil pressure to produce an impact.

A known oil unit has the case having multiple threaded holes extending through, for example, its front surface to fill the case with oil. Each threaded hole receives a screw as a plug. To fill the case with oil, the oil unit is immersed in oil with the screws being removed and thus the threaded holes being open. Some of the threaded holes allow oil to enter, whereas the other threaded holes allow air to flow out, allowing the case to be filled with oil.

When the oil unit operates continuously, the oil is heated and expands to increase the internal pressure of the case. To prevent the resultant oil leakage, the case includes a hollow tube formed from, for example, rubber. The tube contracts in response to an increase in the internal pressure of the case and returns to its original shape in response to a decrease in the internal pressure. This accommodates the volume change of the oil.

### BRIEF SUMMARY

The tube is located behind the threaded holes (oil ports) in the case. The tube may be misaligned and block the oil ports from inside or narrow the flow channel area. This may lower the oil filling performance. This restricts the use of oil with high viscosity and also the structure of the tube. The tube may have two ends bonded together into a ring inward from the oil ports, or the case may include a groove on its inner surface to receive the tube. However, such structures are insufficient to prevent the tube from being misaligned and from blocking the oil ports.

One or more aspects of the present disclosure are directed to an oil unit and a power tool that effectively prevent a tube in a case from blocking an oil port.

A first aspect of the present disclosure provides an oil unit, including:

a case configured to contain oil;

a blade inside the case;

an output shaft holding the blade and protruding from the case;

at least one oil port formed on the case;

a hollow tube adjacent to an inner surface in which the at least one oil port is open in the case; and

a flow channel definer positioning the tube adjacent to an opening of the at least one oil port in the inner surface at a predetermined position and defining a flow channel of oil to flow into the case through the opening.

A second aspect of the present disclosure provides a power tool, including: the above oil unit.

The oil unit and the power tool according to the above aspects of the present disclosure effectively prevent the tube in the case from blocking the oil port.

### BRIEF DESCRIPTION OF DRAWINGS

FIG. 1 is a longitudinal central sectional view of a soft impact driver.

FIG. 2 is an enlarged longitudinal central sectional view of an oil unit.

FIG. 3 is a sectional view taken along line A-A in FIG. 2.

FIG. 4A is a rear perspective view of a front case.

FIG. 4B is a longitudinal central sectional view of the front case taken along threaded holes.

FIG. 5 is a sectional view taken along line B-B in FIG. 2.

FIG. 6 is a sectional view taken along line C-C in FIG. 2.

FIG. 7A is a rear perspective view of a front case in a first modification.

FIG. 7B is a longitudinal central sectional view of the front case taken along threaded holes in the first modification.

FIG. 8 is a longitudinal sectional view of an oil unit according to the first modification.

FIG. 9A is a rear perspective view of a front case in a second modification.

FIG. 9B is a longitudinal central sectional view of the front case taken along threaded holes in the second modification.

FIG. 10 is a longitudinal sectional view of an oil unit according to the second modification.

### DETAILED DESCRIPTION

Embodiments of the present disclosure will now be described with reference to the drawings.

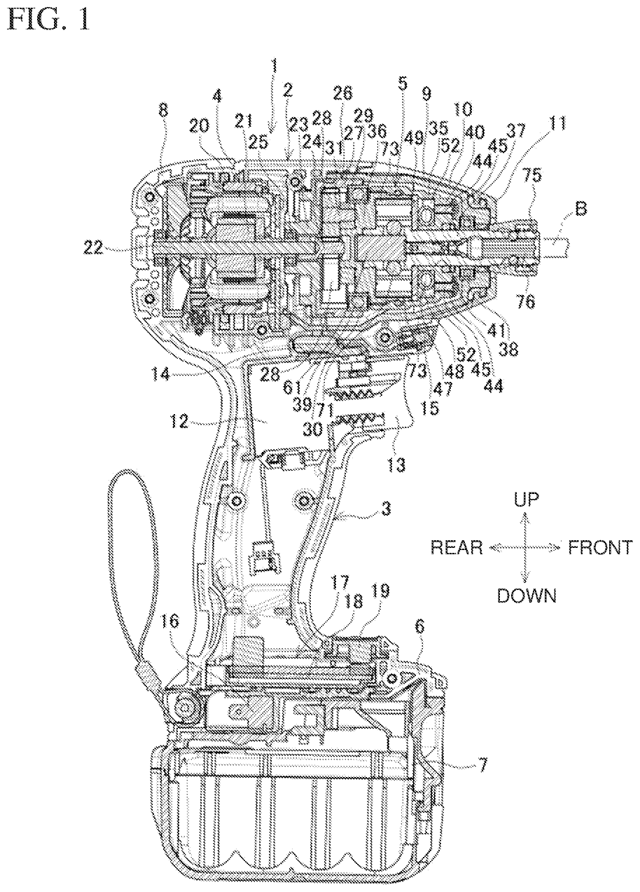

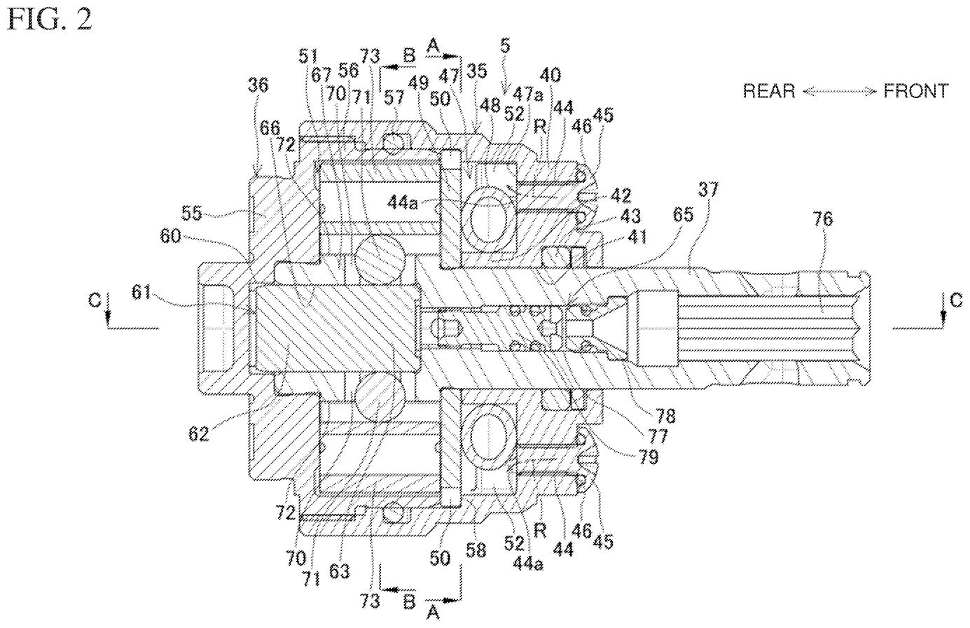

FIG. 1 is a longitudinal central sectional view of a rechargeable soft impact driver 1 as an example of a power tool. FIG. 2 is an enlarged longitudinal central sectional view of an oil unit.

A soft impact driver may also be referred to as an oil pulse driver or an impulse driver. A power tool according to one or more embodiments of the present disclosure may be any tool that includes an oil unit containing oil.

The soft impact driver 1 includes a body 2 and a grip 3. The body 2 includes a central axis extending in the front-rear direction. The body 2 accommodates a motor 4 in its rear portion and an oil unit 5 in its front portion. The grip 3 protrudes downward from the body 2. A battery mount 6 is located at the lower end of the grip 3. The battery mount 6 can receive a battery pack 7 as a power supply attachable from the front.

The soft impact driver 1 includes a housing including a body housing 8, a unit case 9, and a unit case cover 10. The body housing 8 integrates the rear portion of the body 2, the grip 3, and the battery mount 6 together.

The unit case 9 is a tapered cylinder extending frontward from the body housing 8. The unit case 9 includes a rear portion held by the body housing 8. The unit case cover 10 is located frontward from the body housing 8 to cover the unit case 9 from the front. The unit case cover 10 includes a rubber bumper 11 on its front end.

The grip 3 accommodates a switch 12 in its upper portion. The switch 12 causes a trigger 13 to protrude frontward. A forward-reverse switch button 14 for switching the rotation of the motor 4 is located above the switch 12. In front of the forward-reverse switch button 14, a light 15 is located to illuminate ahead.

The battery mount 6 accommodates a terminal block 16. The terminal block 16 is electrically connectable to the battery pack 7. A controller 17 is located above the terminal block 16. The controller 17 includes a control circuit board 18. The controller 17 is parallel to the terminal block 16. A switch panel 19 is located above the controller 17. The switch panel 19 includes, for example, an impact switch button.

The motor 4 is a brushless motor including a stator 20 and a rotor 21. The rotor 21 includes a rotational shaft 22 along its axis. The rotational shaft 22 extends in the front-rear direction.

The body housing 8 holds a disk-shaped gear case 23 in front of the motor 4. The rotational shaft 22 receives a pinion 24 on its front end. The rotational shaft 22 extends through the center of the gear case 23 to cause the pinion 24 to protrude frontward. The gear case 23 holds a bearing 25 supporting the rotational shaft 22.

A reducer 26 is located in front of the gear case 23. The reducer 26 includes an internal gear 27, three planetary gears 28, and a carrier 29.

The internal gear 27 is integrally fixed to a front portion of the gear case 23. The internal gear 27 includes a cylinder 30 extending frontward on its front end. The cylinder 30 is placed in the rear portion of the unit case 9 to be connected to the unit case 9.

Each planetary gear 28 is supported by the carrier 29 with a pin 31 extending through the center of the planetary gear 28. The carrier 29 is fixed to the rear surface of a rear case 36 in the oil unit 5. The planetary gears 28 surround and mesh with the pinion 24 in the internal gear 27.

The oil unit 5 includes a front case 35, the rear case 36, and a spindle 37, as also shown in FIG. 2. The oil unit 5 is coaxially supported by a front bearing 38 and a rear bearing 39 in the unit case 9 in a rotatable manner. The front bearing 38 is located between a front portion of the unit case 9 and the spindle 37. The rear bearing 39 is located between the cylinder 30 and the rear case 36.

The front case 35 is cylindrical and has the diameter decreasing frontward in a stepwise manner. The front case 35 includes a disk-shaped front surface 40. The front surface 40 includes a central cylinder 42 extending rearward. The central cylinder 42 includes a shaft hole 41 through which the spindle 37 extends. A sealing O-ring 43 is located between the shaft hole 41 and the spindle 37.

A pair of threaded holes 44 serving as oil ports extend through the front surface 40 radially outside the shaft hole 41. The pair of threaded holes 44 receive a pair of screws 45 as plugs from the front each with an O-ring 46 in between. The central cylinder 42 protrudes rearward beyond the threaded holes 44 to define an annular front chamber 47 behind the front surface 40.

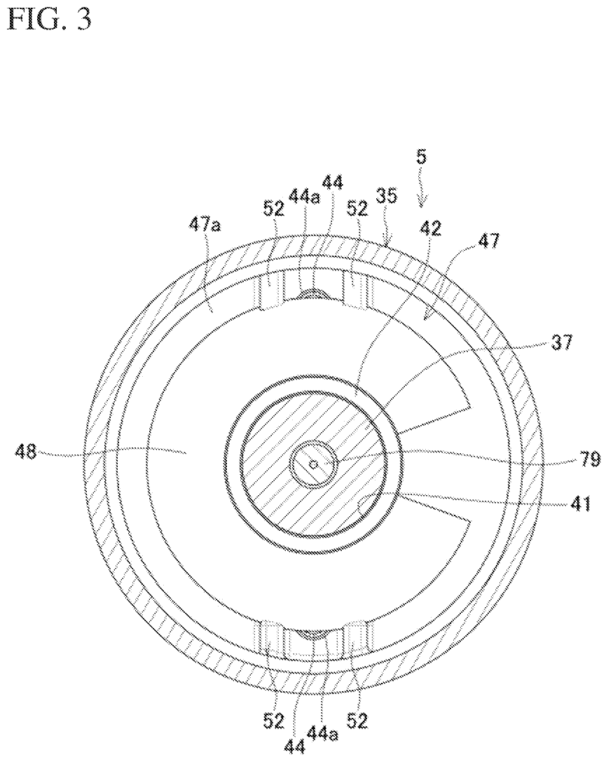

The front chamber 47 accommodates a tube 48. The tube 48 is hollow and has two closed ends. The tube 48 encloses air. As shown in FIG. 3, the tube 48 is accommodated in a C shape as viewed from the rear to surround the central cylinder 42. A partition 49 is located behind the tube 48. The partition 49 includes multiple cutouts 50 on its outer periphery. A rear chamber 51 is located behind the partition 49. The rear chamber 51 connects with the front chamber 47 through the cutouts 50.

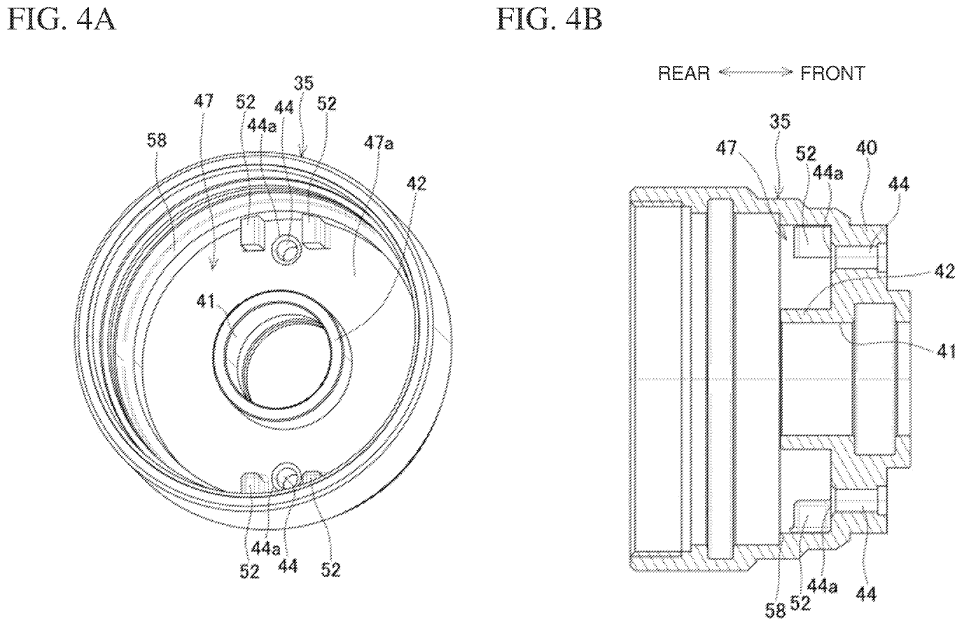

In the front case 35, four ribs 52 extend from a front inner surface 47a of the front chamber 47. As shown in FIG. 4A, pairs of ribs 52 are located at a predetermined interval in the circumferential direction of the front surface 40. The ribs 52 in each pair are located across an opening 44a of the corresponding threaded hole 44. The pair of ribs 52 extend parallel to the radial direction of the front surface 40 in which a radius extends through the center of the threaded hole 44. The pair of ribs 52 have radially inner end faces being in front of and behind the substantial center of the threaded hole 44 in the circumferential direction. Each rib 52 protrudes rearward with a height greater than a half of the distance between the front inner surface 47a of the front chamber 47 and the front surface of the partition 49 in the front-rear direction.

The tube 48 is wound around the central cylinder 42 radially inward from the ribs 52. Thus, the tube 48 is in contact with the front inner surface 47a of the front chamber 47 and the front surface of the partition 49 in the front-rear direction. The tube 48 is in contact with the ribs 52 and the outer circumferential surface of the central cylinder 42 in the radial direction.

The tube 48 is thus positioned in the front chamber 47.

In this state, as shown in FIG. 3, the opening 44a of each threaded hole 44 has an inner portion overlapping the tube 48 in the radial direction of the front surface 40 as viewed from the rear. However, the opening 44a of each threaded hole 44 has an outer portion not overlapping the tube 48 in the radial direction of the front surface 40. As indicated by two-dot-dash arrows in FIG. 2, the front chamber 47 thus includes flow channels R to allow oil to flow into the front chamber 47 through the openings 44a of the threaded holes 44.

The rear case 36 has a rear surface 55 and a side wall 56. The rear surface 55 is disk-shaped. The side wall 56 is cylindrical and protrudes frontward from the periphery of the rear surface 55. The side wall 56 is screwed into the front case 35 from the rear and connected to the front case 35. A sealing O-ring 57 is located between the side wall 56 and the front case 35.

The side wall 56 has its front end in contact with the partition 49. The front case 35 has a step 58 on its inner surface. The step 58 is in contact with the front surface of the partition 49. The partition 49 is held stably between the side wall 56 and the step 58.

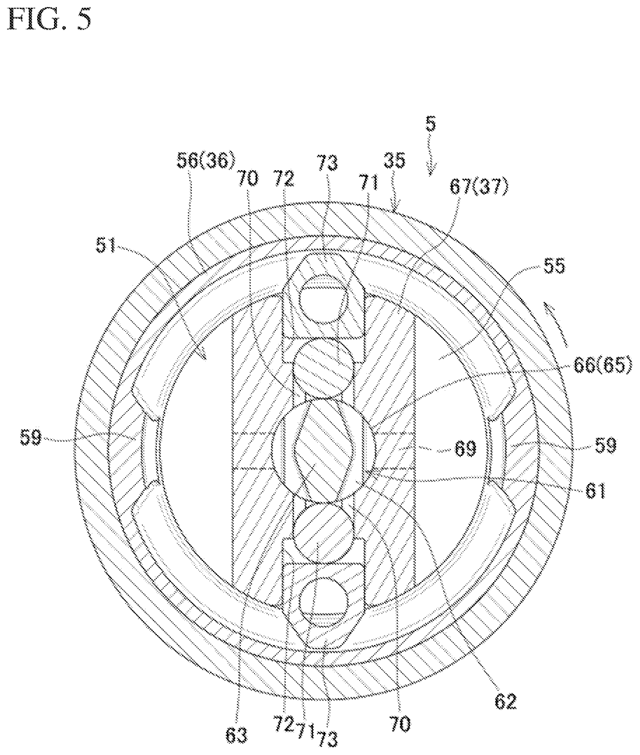

As shown in FIG. 5, the side wall 56 includes a pair of projections 59 on its inner circumferential surface. The pair of projections 59 are point-symmetric to each other about the axis of the rear case 36 and are raised inward. The projections 59 each have a sloped cross section with the circumferential width decreasing radially inward.

The rear surface 55 of the rear case 36 includes a receiving recess 60 at its center. The receiving recess 60 receives a cam 61 facing frontward in its center portion. The cam 61 includes, at the rear, a flat portion 62 with a width across flats. The cam 61 includes, at the front, a thinner portion 63 with a thickness gradually decreasing radially outward from the thickest center. The flat portion 62 and the thinner portion 63 are orthogonal to a straight line connecting the centers of the pair of projections 59 as viewed from the front.

The spindle 37 includes a through-hole 65 along the axis. The through-hole 65 defines, in its rear portion, a pressurized enclosure 66 in the rear chamber 51. The pressurized enclosure 66 has a circular cross section. The pressurized enclosure 66 receives the cam 61 in a relatively rotatable manner. The spindle 37 has a rear end located outside the cam 61 and supported in the receiving recess 60 on the rear case 36.

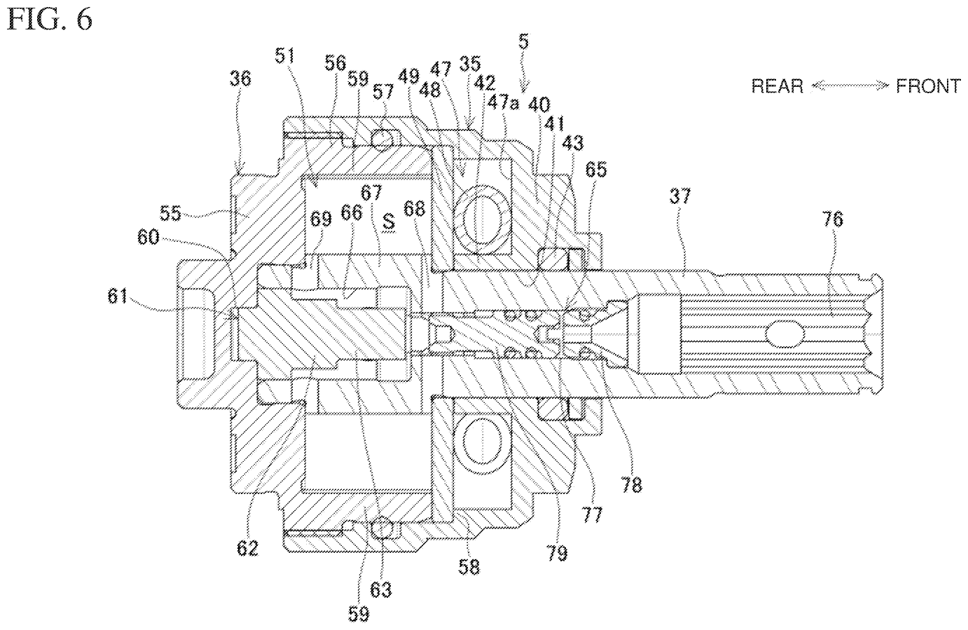

The spindle 37 includes a rear portion 67 having an elongated cross section extending across the diameter of the rear case 36. However, the cross section of the rear portion 67 has a longitudinal dimension shorter than the distance between the pair of projections 59 facing each other. The rear portion 67 is located between the partition 49 and the rear surface 55 of the rear case 36. As shown in FIG. 6, a front connection hole 68 is located in front of the rear portion 67. A rear connection hole 69 is located behind the rear portion 67. The front connection hole 68 and the rear connection hole 69 extend in the radial direction of the spindle 37. The front connection hole 68 and the rear connection hole 69 extend in the direction orthogonal to the radial direction in which the rear portion 67 extends. The front connection hole 68 allows connection between a pressure-regulating hole 77 (described later) in the through-hole 65 and the rear chamber 51 when the rear portion 67 is in contact with the partition 49. The rear connection hole 69 allows connection between the pressurized enclosure 66 and the rear chamber 51 when the rear portion 67 is in contact with the rear surface 55.

The rear portion 67 includes a pair of holes 70 radially outside the thinner portion 63 of the cam 61. The holes 70 connect with the pressurized enclosure 66. The holes 70 extend in the radial direction of the spindle 37. The holes 70 extend in the direction in which the rear portion 67 extends. The holes 70 each receive a ball 71. Each ball 71 is radially movable in the hole 70. The balls 71 moving inward can come in contact with the thinner portion 63 of the cam 61.

A pair of holding grooves 72 are located on the longitudinal ends of the rear portion 67. The holding grooves 72 connect with the respective holes 70. The holding grooves 72 each extend in the front-rear direction and are open along the longitudinal ends of the rear portion 67.

Each holding groove 72 receives a blade 73. Each blade 73 has a width substantially within the circumferential width of the holding groove 72. Each blade 73 has a length within the entire length of the holding groove 72 in the front-rear direction. Each blade 73 is held in the holding groove 72 in a manner movable in the radial direction of the spindle 37. The blades 73 moving inward can come in contact with the balls 71. Each blade 73 has its radially outer end with a width decreasing radially outward to slope.

The spindle 37 has a front end protruding frontward through the unit case 9 and the unit case cover 10. A sleeve 75 for attaching or detaching a bit B (FIG. 1), such as a screwdriver bit, is located at the front end of the spindle 37.

The through-hole 65 has, in its front portion, a bit insertion hole 76 at the front and the pressure-regulating hole 77 behind the bit insertion hole 76. The bit insertion hole 76 receives the bit B. The pressure-regulating hole 77 has a smaller diameter than the bit insertion hole 76. The bit insertion hole 76 receives, at its rear end, a bit piece 78. The bit piece 78 receives the rear end of the bit B. The pressure-regulating hole 77 receives a pressure valve 79 behind the bit piece 78. The pressure valve 79 is screwed and sealed in the pressure-regulating hole 77. The pressure valve 79 moves in the axial direction through screw engagement in response to a rotational operation from the front to adjust oil pressure (output).

The pressure valve 79, the front case 35, the rear case 36, the screws 45, the spindle 37, and other components define a sealed space S (FIG. 6) including the front chamber 47 and the rear chamber 51. The sealed space S contains oil.

To fill the oil unit 5 with oil, the screws 45 in the front surface 40 are removed to open the threaded holes 44. The oil unit 5, excluding a front portion of the spindle 37, is immersed in oil with the spindle 37 facing upward. In this state, the spindle 37 is slightly tilted with respect to the vertical direction. The tilt allows the oil to enter one lower threaded hole 44 and air to flow out through the other threaded hole 44 to fill the oil unit 5.

The tube 48 in the front chamber 47 is positioned by the ribs 52. The oil flowing in through the threaded hole 44 thus enters the front chamber 47 through the flow channel R without being obstructed by the tube 48 and is then injected into the rear chamber 51 through the cutouts 50 in the partition 49.

A user holding the grip 3 pulls the trigger 13 with the bit B received in the bit insertion hole 76 in the spindle 37. The switch 12 is then turned on to cause the battery pack 7 to supply a three-phase current to the motor 4 through the control circuit board 18, thus rotating the rotor 21. This rotates the rotational shaft 22 integrally with the rotor 21.

The rotation of the rotational shaft 22 is transmitted to the planetary gears 28 with the pinion 24. The planetary gears 28 revolving in the internal gear 27 reduce the rotation to be transmitted to the rear case 36 of the oil unit 5 through the carrier 29. The rear case 36 thus rotates together with the front case 35.

The cam 61 rotates in the direction indicated by an arrow in FIG. 5 together with the rear case 36 in the oil unit 5. The thinner portion 63 of the cam 61 then pushes the blades 73 out of the rear portion 67 with the balls 71 in protruding directions. The thinner portion 63 is rotated further to be parallel to the rear portion 67 as shown in FIG. 5. At this position, the thinner portion 63 pushes the balls 71 and the blades 73 most outward.

When the rear case 36 and the cam 61 rotate still further, the blades 73 come in contact with the projections 59. At this rotational position, the thinner portion 63 closes the path between the rear connection hole 69 and the pressurized enclosure 66, increasing the oil pressure inside the pressurized enclosure 66. This retains the blades 73 that have been pushed out. The blades 73 hitting the projections 59 produce impact torque (impact) in the spindle 37. After the impact torque is produced, each blade 73 retracts inward with the slope guided along the slope on the corresponding projection 59. The oil in the pressurized enclosure 66 flows into the rear chamber 51 through the clearance between the components, thus allowing the blades 73 to retract. The retracted blades 73 move relatively over the projections 59.

After the blades 73 move over the projections 59, the rear connection hole 69 and the pressurized enclosure 66 connect with each other as the rear case 36 and the cam 61 rotate. The cam 61 pushes the blades 73 with the balls 71 again. The repeated operation produces the impact torque twice per rotation of the rear case 36. This allows screwing or other operations using the bit B received in the bit insertion hole 76 in the spindle 37.

The oil unit 5 and the soft impact driver 1 in the embodiment include the unit case 9 (case) that contains oil, the blades 73 inside the unit case 9, the spindle 37 (output shaft) holding the blades 73 and protruding from the unit case 9, the threaded holes 44 (oil port) in the unit case 9, and the hollow tube 48 on the front inner surface 47a (an example of an inner surface) of the front chamber 47 in which the threaded holes 44 are open in the unit case 9.

The oil unit 5 and the soft impact driver 1 further include the ribs 52 (flow channel definer) positioning the tube 48 adjacent to the openings 44a of the threaded holes 44 in the front inner surface 47a at a predetermined position and defining the flow channels R of oil flowing in through the openings 44a.

This structure effectively prevents the tube 48 in the unit case 9 from blocking the threaded holes 44 from inside or from narrowing the flow channel area. This structure has less restrictions on the viscosity of oil and the structure of the tube.

The flow channel definer includes the ribs 52 (protrusions) extending from the front inner surface 47a.

The flow channel definer is thus formed easily.

The flow channel definer includes the multiple ribs 52.

The tube 48 is thus positioned reliably.

The ribs 52 position the tube 48 on the front inner surface 47a to have the openings 44a being unblocked.

With the tube 48 on the front inner surface 47a, the flow channels R are thus retained.

The threaded holes 44 are located in the front surface 40 of the unit case 9 from which the spindle 37 protrudes. The front surface 40 is disk-shaped. The ribs 52 extend parallel to the radial direction of the front surface 40 on the front inner surface 47a of the front surface 40.

Thus, the ribs 52 guide the oil flow.

The pair of ribs 52 are located across the opening 44a in the circumferential direction of the front surface 40.

This structure prevents the tube 48 from blocking the threaded holes 44 and guides the flow of the oil effectively.

The oil ports include the threaded holes 44 closed by the screws 45.

The oil ports operable to be open and closed can be formed easily.

Although the ribs have radial lengths with the inner end faces being in front of and behind the substantially center of the threaded hole in the circumferential direction in the above embodiment, the ribs may have other radial lengths. Each rib may extend to have the inner end face being beyond the center of the threaded hole or beyond the entire threaded hole.

The structures of the ribs as the flow channel definer are not limited to those described in the above embodiment.

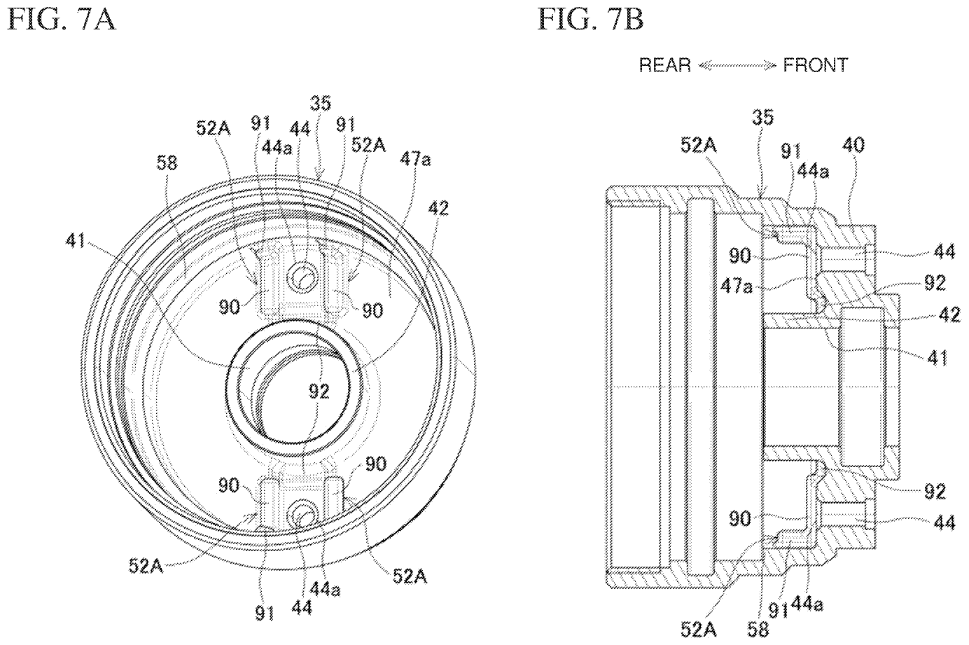

The front case 35 in a first modification shown in FIGS. 7A and 7B includes L-shaped ribs 52A located across the opening 44a. Each rib 52A includes a radial portion 90 and an axial portion 91. The radial portion 90 extends parallel to the radial direction of the front surface 40 on the front inner surface 47a of the front chamber 47. The axial portion 91 extends rearward from a radially outer end of the radial portion 90 on the inner circumferential surface of the front case 35.

The front inner surface 47a of the front chamber 47 includes recesses 92 each between radially inner ends of the radial portions 90 and the central cylinder 42. Each recess 92 extends linearly in a direction tangential to the central cylinder 42 to connect the ends of the radial portions 90.

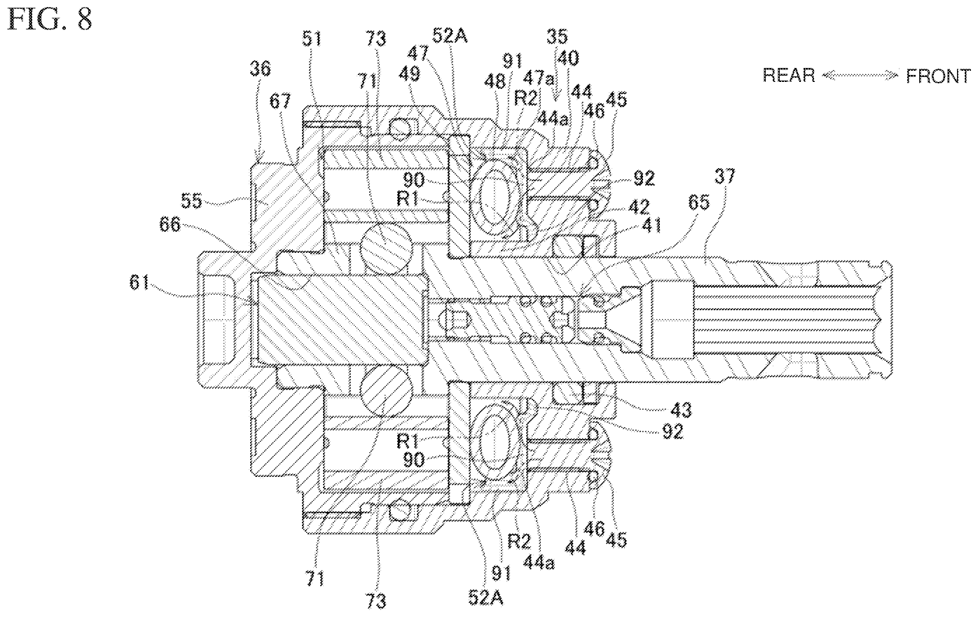

In the oil unit 5 with the front case 35 in the first modification, as shown in FIG. 8, the tube 48 is in contact with the rear surfaces of the radial portions 90 of the ribs 52A and the front surface of the partition 49 in the front-rear direction. The tube 48 is in contact with the axial portions 91 of the ribs 52A in the radial direction. The tube 48 is thus positioned. In this state, clearances having the thickness of the radial portions 90c are left in the front-rear direction between the tube 48 and the openings 44a. The clearances connect with the recess 92. Clearances having the thickness of the axial portions 91 are left in the radial direction between the tube 48 and the inner circumferential surface of the front case 35.

As indicated by two-dot-dash arrows in FIG. 8, the front chamber 47 thus includes flow channels R1 to allow oil flowing in through the openings 44a to flow between the radial portions 90 and between the tube 48 and the central cylinder 42 into the front chamber 47 along the inner circumference of the tube 48. In this example with the recesses 92, the oil flowing through the flow channels R1 flows also into the recesses 92 and thus easily flows toward the inner circumference of the tube 48. The front chamber 47 also includes flow channels R2 to allow the oil flowing in through the openings 44a to flow between the axial portions 91 and between the tube 48 and the inner circumferential surface of the front case 35 into the front chamber 47 along the outer circumference of the tube 48.

In the first modification as well, the tube 48 is positioned by the ribs 52A in the front chamber 47. The oil flowing in through the threaded holes 44 thus enters the front chamber 47 through the flow channels R1 and R2 without being obstructed by the tube 48, and is then injected into the rear chamber 51. This effectively prevents the tube 48 from blocking the threaded holes 44.

In particular, the ribs 52A position the tube 48 spaced from the front inner surface 47a. This reliably prevents the tube 48 from blocking the openings 44a.

The front inner surface 47a includes the recesses 92 connecting with the flow channels R1. This facilitates oil flow toward the inner circumference on which the recesses 92 are located.

In the first modification, each recess 92 may extend to have two ends located outward beyond the two ribs 52A.

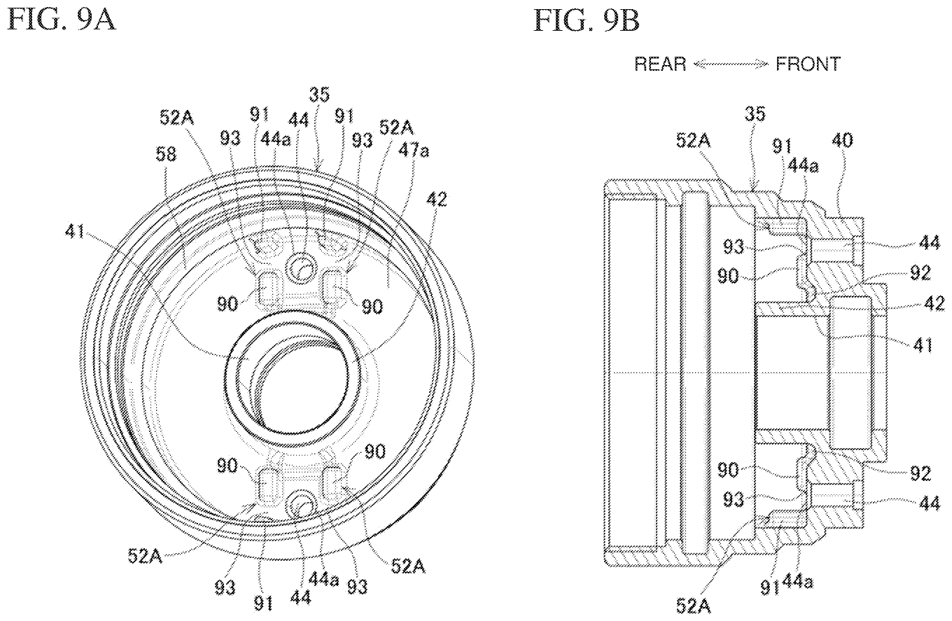

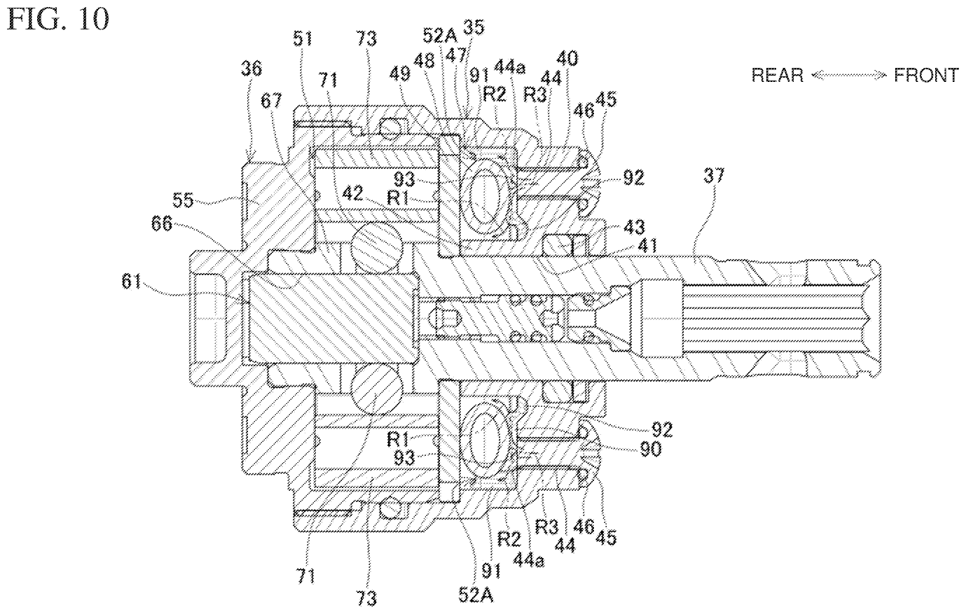

The front case 35 in a second modification shown in FIGS. 9A and 9B includes the radial portions 90 shorter than the radial portions 90 in the ribs 52A in FIGS. 7A and 7B and cutouts 93 each between the radial portion 90 and the axial portion 91. The cutouts 93 allow the space between the pair of ribs 52A to connect with the front chamber 47 in the circumferential direction. As indicated by two-dot-dash arrows in FIG. 10, the radial portions 90 and the axial portions 91 define flow channels R3 to allow the oil flowing in through the openings 44a to flow through the cutouts 93 between the ribs 52A circumferentially outward into the front chamber 47, in addition to the flow channels R1 and R2 as in FIGS. 7A and 7B.

In the second modification as well, the tube 48 is positioned by the ribs 52A in the front chamber 47. The oil flowing in through the threaded holes 44 thus enters the front chamber 47 through the flow channels R1, R2, and R3 without being obstructed by the tube 48 and is then injected into the rear chamber 51. This effectively prevents the tube 48 from blocking the threaded holes 44.

In particular, the ribs 52A include the cutouts 93 defining a large flow channel area.

In the second modification, each rib may include a cutout with a different width. One of the two ribs, rather than the two ribs, may include the cutout.

In the above embodiments, the ribs adjacent to the corresponding threaded hole are not limited to a pair of ribs. One of the two ribs may be located adjacent to the corresponding threaded hole.

The width and height of each rib may be modified as appropriate.

The ribs are not limited to being linear and may be curved.

The flow channel definer is not limited to the ribs and may be, for example, one or more circular or prismatic protrusions surrounding the threaded hole. Multiple protrusions with different shapes may be combined. The positions and number of the recesses may be modified as appropriate. The combination of the protrusion and the recess may also be modified as appropriate.

The positions and number of the threaded holes are not limited to the above examples. For example, the threaded holes may be radially more inward than in the above examples, and may be other than the pair of threaded holes, or specifically, three or more threaded holes.

The oil ports are not limited to the threaded holes and may be simple through-holes. In this case, a plug other than a screw may be used.

The shape of the tube is not limited to the above examples. The tube may be a ring with a continuous circumference. The flow channel definer may be a tube, other than the rib and the protrusion, with a shape to avoid the oil ports.

The case is not limited to the unit case including the front case and the rear case in the above examples. The case may include three or more parts. The case may include two split parts in the lateral or vertical direction, instead of the front-rear direction. The partition may be eliminated not to separate the front chamber and the rear chamber.

An oil unit to be used may include no balls and no coil springs, use relative rotation of the case and the spindle to swing the blades in the case, and thus control the oil pressure. For example, such an oil unit may include, in a spindle, one or more blades that are urged radially outward. The blades each have one side that intermittently receives high fluid pressure as a case defining an oil chamber rotates. In this structure, the blades tilt in the rotation direction to be sealed by a sealing portion in the case and a groove on the spindle. The blades are thus pressed against the spindle, creating an impact to rotate the spindle.

The motor is not limited to a brushless motor but may be a commutator motor. The present disclosure is also applicable to a tool powered by alternating current (AC) without a battery pack.

The power tool is not limited to a soft impact driver. The structure according to one or more embodiments of the present disclosure allows easy injection of oil into an oil unit, and thus is applicable to any power tool including an oil unit.

### REFERENCE SIGNS LIST

1 soft impact driver
2 body
3 grip
4 motor
5 oil unit
8 body housing
9 unit case
22 rotational shaft
26 reducer
35 front case
36 rear case
37 spindle
40 front surface
41 shaft hole
42 central cylinder
44 threaded hole
44a opening
45 screw
47 front chamber
47a front inner surface
48 tube
49 partition
51 rear chamber
52, 52A rib
61 cam
73 blade
90 radial portion
91 axial portion
92 recess
93 cutout
R, R1 to R3 flow channel
B bit

What is claimed is:

1. An oil unit, comprising:
a case configured to contain oil;
a blade inside the case;
an output shaft holding the blade and protruding from the case;
at least one oil port formed on the case;
a hollow tube adjacent to an inner surface in which the at least one oil port is open in the case; and
a flow channel definer positioning the tube adjacent to an opening of the at least one oil port in the inner surface at a predetermined position and defining a flow channel of oil to flow into the case through the opening.

2. The oil unit according to claim 1, wherein
the flow channel definer includes at least one protrusion extending from the inner surface.

3. The oil unit according to claim 2, wherein
the flow channel definer includes a plurality of the protrusions.

4. The oil unit according to claim 2, wherein
the at least one protrusion positions the tube on the inner surface to have the opening being unblocked.

5. The oil unit according to claim 2, wherein
the at least one protrusion positions the tube spaced from the inner surface.

6. The oil unit according to claim 2, wherein
the at least one oil port is located in a front surface of the case from which the output shaft protrudes, and the front surface is disk-shaped, and
the at least one protrusion extends parallel to a radial direction of the front surface on the inner surface of the front surface.

7. The oil unit according to claim 6, wherein
a pair of the protrusions are located across the opening in a circumferential direction of the front surface.

8. The oil unit according to claim 2, wherein
the at least one protrusion includes a cutout.

9. The oil unit according to claim 2, wherein
the inner surface includes a recess connecting with the flow channel.

10. The oil unit according to claim 1, wherein
the at least one oil port includes a threaded hole closed by a screw.

11. A power tool, comprising:
the oil unit according to claim 1.

12. The oil unit according to claim 3, wherein
the at least one protrusion positions the tube on the inner surface to have the opening being unblocked.

13. The oil unit according to claim 3, wherein
the at least one protrusion positions the tube spaced from the inner surface.

14. The oil unit according to claim 3, wherein
the at least one oil port is located in a front surface of the case from which the output shaft protrudes, and the front surface is disk-shaped, and
the at least one protrusion extends parallel to a radial direction of the front surface on the inner surface of the front surface.

15. The oil unit according to claim 4, wherein
the at least one oil port is located in a front surface of the case from which the output shaft protrudes, and the front surface is disk-shaped, and
the at least one protrusion extends parallel to a radial direction of the front surface on the inner surface of the front surface.

16. The oil unit according to claim 5, wherein
the at least one oil port is located in a front surface of the case from which the output shaft protrudes, and the front surface is disk-shaped, and
the at least one protrusion extends parallel to a radial direction of the front surface on the inner surface of the front surface.

17. The oil unit according to claim 3, wherein
the at least one protrusion includes a cutout.

18. The oil unit according to claim 4, wherein
the at least one protrusion includes a cutout.

19. The oil unit according to claim 5, wherein
the at least one protrusion includes a cutout.

20. The oil unit according to claim 6, wherein
the at least one protrusion includes a cutout.
